(19) United States
(12) Patent Application Publication
(10) Pub. No.: US 2014/0021897 A1
(43) Pub. Date: Jan. 23, 2014

(54) ROTARY ELECTRIC MACHINE CONTROL APPARATUS AND ELECTRIC POWER STEERING APPARATUS USING THE SAME

(71) Applicant: DENSO CORPORATION, Kariya-city (JP)

(72) Inventor: Takahiro YAMANAKA, Kariya-city (JP)

(21) Appl. No.: 13/919,171

(22) Filed: Jun. 17, 2013

(30) Foreign Application Priority Data
Jul. 20, 2012 (JP) 2012-161263

(51) Int. Cl. H02P 6/18

(52) U.S. Cl. CPC H02P 6/182
USPC 318/400.34

(57) ABSTRACT

An inverter circuit converts electric power supplied to a motor by on/off operations of FETs. A microcomputer controls driving of the motor by controlling the on/off operations of the FETs. The microcomputer operates as a current direction determination part. The microcomputer detects a first potential difference, which is a potential difference between both ends of each diode, and a second potential difference, which is a potential difference between both ends of each diode, when both FETs of each phase are in an off-state. The microcomputer can further determine a direction of current flowing in the motor based on the detected first potential difference and the detected second potential difference.

### CROSS REFERENCE TO RELATED APPLICATION

This application is based on and incorporates herein by reference Japanese patent application No. 2012-161263 filed on Jul. 20, 2012.

### FIELD

The present disclosure relates to a rotary electric machine control apparatus and an electric power steering apparatus using the same.

### BACKGROUND

A conventional rotary electric machine control apparatus controls driving of a rotary electric machine by detecting phase currents flowing to coils of the rotary electric machine by electronic components such as current sensors. In a rotary electric machine control apparatus disclosed in, for example, JP-A-2005-210871, a shunt resistor is connected for a pair of switching elements corresponding to each phase of an inverter circuit thereby to detect the phase current of each phase.

Since a rotary electric machine includes inductance components, a phase difference arises between a command current provided for driving the rotary electric machine and an actual current flowing actually in each coil of the rotary electric machine. If this phase difference arises, it is likely that the rotary electric machine cannot output a torque as commanded. According to the conventional rotary electric machine control apparatus, a torque, which the rotary electric machine generates, is controlled by feedback control. In the feedback control, a phase difference between a command current and an actual current is calculated by detecting a phase current, that is, an actual current flowing in the rotary electric machine, and the phase difference is corrected by phase compensation control and the like. This rotary electric machine control apparatus needs electronic components such as plural shunt resistors for detecting actual currents flowing in the rotary electric machine. As a result, the rotary electric machine control apparatus becomes complicated and large-sized in configuration, and costly in manufacturing.

In another conventional rotary electric machine control apparatus, voltages developed by switching elements, which form an inverter circuit, or rectifying elements, which are connected in parallel to the switching elements, are detected. An actual current flowing to a coil of each phase is detected based on a temperature of the switching element and a voltage-current characteristic of the element at detection time This rotary electric machine control apparatus, however, needs a temperature detecting element such as a thermistor for detecting an element temperature. It further needs a memory device such as a ROM for storing voltage-current characteristics for different temperatures. As a result, the rotary electric machine control apparatus is not sized small readily.

### SUMMARY

It is an object to provide a rotary electric machine control apparatus, which determines a direction of current flowing in a coil of each phase of a rotary electric machine in a simple configuration.

According to one aspect, a rotary electric machine control apparatus is provided for controlling driving of a rotary electric machine, which has a coil set formed of coils corresponding to plural phases. The rotary electric machine control apparatus comprises a power converter and a control unit.

The power converter includes plural switching elements, a first rectifying element and a second rectifying element. The plural switching elements form switching element pairs by a first switching element and a second switching element, which are provided at a high-potential side and a low-potential side of a power source, respectively, in correspondence to each phase of the coils. The first rectifying element is provided in parallel to the first switching element. The second rectifying element is provided in parallel to the second switching element. The power converter converts power supplied form the power source to the rotary electric machine by on/off operations of the first switching element and the second switching element.

The control unit controls the on/off operations of the first switching element and the second switching element thereby to control driving of the rotary electric machine.

The control unit includes a current direction determination part, which detects a first potential difference between both ends of the first rectifying element and a second potential difference between both ends of the second rectifying element when the first switching element and the second switching element are both in an off-state, and determines a direction of a current flowing in each phase of the coils based on the first potential difference and the second potential difference.

### BRIEF DESCRIPTION OF THE DRAWINGS

The above and other objects, features and advantages will become more apparent from the following detailed description made with reference to the accompanying drawings. In the drawings:

FIG. 1 is a circuit diagram of a rotary electric machine control apparatus according to one embodiment;

FIG. 2 is a schematic view of an electric power steering apparatus using the rotary electric machine control apparatus of the first embodiment;

FIG. 3 is a time chart showing changes of a first potential difference and a second potential difference, which are caused by on/off operations of a first switching element and a second switching element, respectively, in case a current flows from an inverter to a motor;

FIG. 4 is a time chart showing changes of the first potential difference and the second potential difference, which are caused by on/off operations of the first switching element and the second switching element, respectively, in case the current flows from the motor to the inverter; and

FIG. 5A, FIG. 5B and FIG. 5C are simplified circuit diagrams of a part of a rotary electric machine control apparatus according to other embodiments of the present disclosure.

### DETAILED DESCRIPTION OF THE PREFERRED EMBODIMENT

A rotary electric machine control apparatus according to embodiments will be described with reference to the drawings.

### One Embodiment

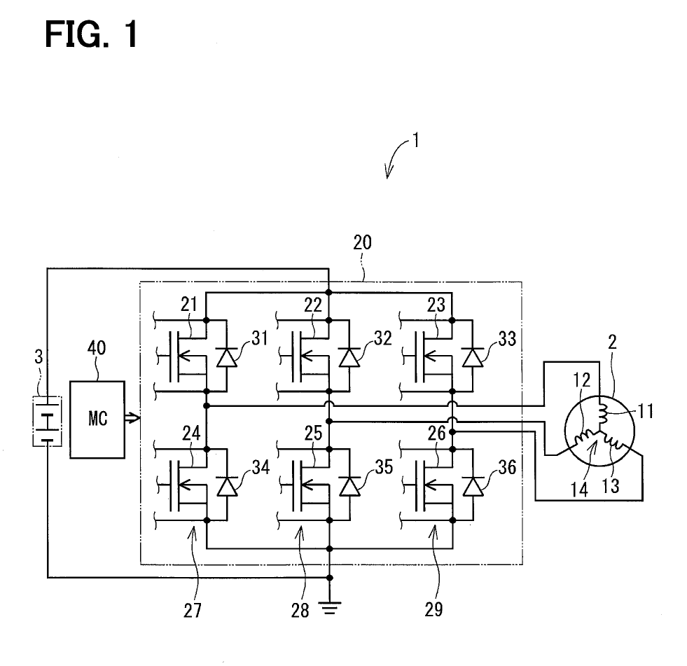

A rotary electric machine control apparatus according to one embodiment is shown in FIG. 1. The rotary electric machine control apparatus 1 is provided to control electric power supplied to a motor 2, which is a rotary electric machine, thereby to control driving of the motor 2. The rotary electric machine control apparatus 1 as well as the motor 2 are used in, for example, an electric power steering apparatus, which assists a steering operation of a vehicle.

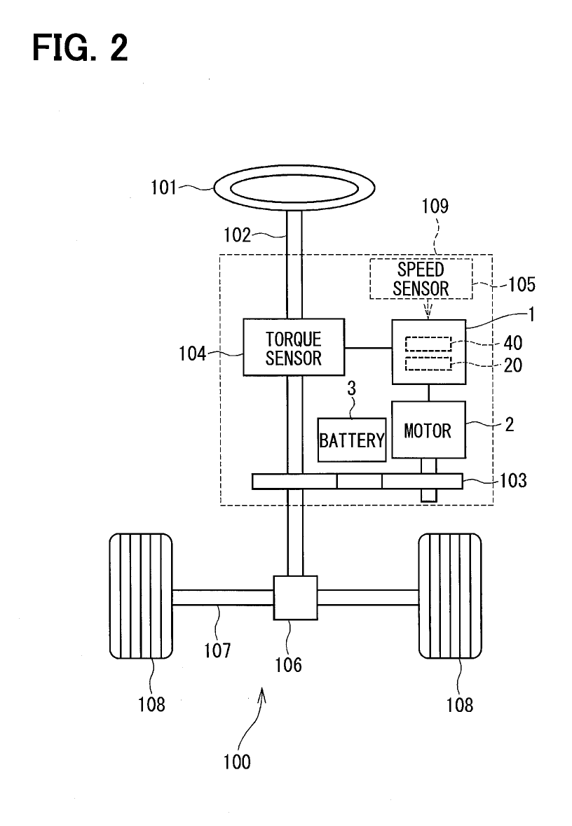

FIG. 2 shows an entire configuration of a steering system 100, which includes an electric power steering apparatus 109. The electric power steering apparatus 109 is provided with a torque sensor 104, which is attached to a steering shaft 102 coupled to a steering wheel 101. The torque sensor 104 detects a steering torque applied to the steering shaft 102 by a driver through the steering wheel 101.

A pinion gear 106 is attached to a top end of the steering shaft 102. The pinion gear 106 is engaged with a rack shaft 107. A pair of tire wheels 108 is rotatably coupled to ends of the rack shaft 107 through tie rods and the like. Thus, when the driver rotates the steering wheel 101, the steering shaft 102 coupled to the steering wheel 101 is rotated. Rotary movement of the steering shaft 102 is converted into linear movement of the rack shaft 107 by the pinion gear 106. The pair of tire wheels 108 is steered by an angle corresponding to the linear movement of the rack shaft 107.

The electric power steering apparatus 109 includes a motor 2, a rotary electric machine control apparatus 1, a reduction gear 103 and the like. The motor 2 generates steering assist torque. The rotary electric machine control apparatus 1 controls driving of the motor 2. The reduction gear 103 transfers the rotation of the motor 2 to the steering shaft 102 and the rack shaft 107 while reducing rotation. The motor 2 is, for example, a three-phase brushless motor, and has a rotor and a stator, which are not shown. The rotor is a disk-shaped member, on which permanent magnets are attached to provide magnetic poles. The stator houses the rotor therein and rotatably supports the rotor. The stator includes protrusions, which protrude radially inward at every predetermined angular interval. On the protrusions, a U-phase coil (U-coil) 11, a V-phase coil (V-coil) 12 and a W-phase coil (W-coil) 13 shown in FIG. 1 are wound. The U-coil 11, the V-coil 12 and the W-coil 13 are windings, which correspond to the U-phase, the V-phase and the W-phase respectively, and form jointly a coil set 14.

The motor 2 is driven by electric power supply from a battery 3 provided as a power source. The motor 2 rotates the reduction gear 103 in a normal direction and a reverse direction. The electric power steering apparatus 109 includes a vehicle speed sensor 105, which detects a travel speed of a vehicle, in addition to the torque sensor 104. The electric power steering apparatus 109 configured as described above generates the steering assist torque for assisting the steering operation of the steering wheel 101 from the motor 2 based on signals from the torque sensor 104, the speed sensor 105 and the like. This torque is transferred to the steering shaft 102 or the rack shaft 107.

The rotary electric machine control apparatus 1 will be described next with reference to FIG. 1. The rotary electric machine control apparatus 1 is provided with an inverter circuit 20, which is a power converter, a microcomputer 40 and the like. The inverter circuit 20 includes switching elements 21 to 26. The inverter circuit 20 is a three-phase inverter, in which six switching elements 21 to 26 are connected in a bridge form to switch over power supply to each of the U-coil 11, the V-coil 12 and the W-coil 13 of the coil set 14. The switching elements 21 to 26 are metal-oxide-semiconductor field-effect transistors (MOSFETs). The switching elements 21 to 26 are referred to FETs, respectively, when appropriate.

Three FETs 21 to 23 have drains connected to the positive-polarity side of the battery 3 provided as the power source. Sources of the FETs 21 to 23 are connected to drains of the FETs 24 to 26, respectively. Sources of the FETs 24 to 26 are connected to the negative-polarity side of the battery 3, that is, grounded. A junction between the FET 21 and the FET 24, which are paired, is connected to one terminal of the U-coil 11. A junction between the FET 22 and the FET 25, which are paired, is connected to one terminal of the V-coil 12. A junction between the FET 23 and the FET 26, which are paired, is connected to one terminal of the W-coil 13.

The FETs 21 to 23 correspond to first switching elements in the inverter circuit 20. The FETs 24 to 26 correspond to second switching elements in the inverter circuit 20. The first switching element and the second switching element are referred to as a high-side FET (H-FET) and a low-side FET (L-FET), respectively, below when appropriate. Further, in some occasions, a corresponding phase U, V or W is also identified as exemplified as U-L-FET 24. Still further, when appropriate, the pair of the FET 21 and the FET 24, the pair of the. FET 22 and the FET 25 and the pair of the FET 23 and the FET 26 are referred to as a switching element pair 27, a switching element pair 28 and a switching element pair 29, respectively.

The inverter circuit 20 further includes diodes 31 to 36, which are connected in parallel to the FETs 21 to 26, respectively. A MOSFET has a diode (rectifying element), which is referred to as a parasitic diode, between a source-drain path thereof structurally. The diodes 31 to 36 are parasitic diodes of the FETs 21 to 26, respectively. The diodes 31 to 36 are referred to as the parasitic diodes 31 to 36, respectively, when appropriate. The diodes 31 to 33 correspond to first rectifying elements in correspondence to the first switching elements 21 to 23, respectively The diodes 34 to 36 correspond to second rectifying elements in correspondence to second switching elements 24 to 26, respectively The diodes 31 to 36 are reverse-biased in a direction to allow current flow only from the source sides (low-potential sides) to the drain sides (high-potential sides) of the FETs 21 to 26, respectively.

The rotary electric machine control apparatus 1 thus has one system of inverter (inverter circuit 20). The inverter circuit 20 operates under control of a microcomputer (MC) 40 described below and converts the power supplied from the battery 3 to the motor 2 thereby to rotationally drive the motor 2. The inverter circuit 20 converts the power supplied from the battery 3 to the motor 3 by the on/off operations of the FETs 21 to 26.

The microcomputer 40 is a semiconductor package, which includes an arithmetic part, a memory part, an input/output part and the like. The microcomputer 40 controls operations of various devices and apparatuses mounted in a vehicle in response to signals from the sensors provided at various parts of the vehicle and based on programs stored in the memory part. The microcomputer 40 primarily controls driving of the motor 2 of the electric power steering apparatus 109.

The microcomputer 40 calculates command currents in accordance with the signals from the torque sensor 104, the speed sensor 105 and the like so that the motor 2 generates the steering assist torque for assisting the steering operation of the steering wheel 101. The microcomputer 40 controls the on/off operations of the FETs 21 to 26 of the inverter circuit 20 so that the calculated command currents flow in the U-coil 11, the V-coil 12 and the W-coil 13 of the motor 2. Thus the power supplied from the battery 3 to the motor 2 is converted so that actual currents corresponding to the command currents flow in the U-coil 11, the V-coil 12 and the W-coil 13 of the motor 2. The motor 2 is driven to rotate for applying the steering assist torque to the steering shaft 102 and the rack shaft 107. Since the motor 2 has inductance components, phase differences arise between the command currents for driving the motor 2 and the actual currents flowing actually in the U-coil 11, the V-coil 12 and the W-coil 13 of the motor 2.

Although not shown, a customized integrated circuit (IC) is provided between the microcomputer 40 and both ends of each diode 31 to 36. The customized IC includes a differential amplifier circuit and a comparator circuit. The microcomputer 40 is thus enabled to detect a small potential difference between the ends of each diode 31 to 36 through the customized IC. When appropriate, the potential difference between both ends of each diode 31 to 33 is referred to as a first potential difference (Vh) in correspondence to the first switching elements and the first rectifying elements, which are at the high-potential side, and the potential difference between both ends of each diode 34 to 36 is referred to as a second potential difference (Vl) in correspondence to the second switching elements and the second rectifying elements, which are at the low-potential side. The forward voltage of each diode 31 to 36 is referred to as Vf. The microcomputer 40 and the customized IC correspond to a control unit.

The microcomputer 40 provides a dead time for each switching pair 27, 28, 29 in respect of the operation of each switching element (FETs 21 to 26). The dead time is a period, in which both of the H-FET and the L-FET (FET 21 and FET 24, FET 22 and FET 25, FET 23 and FET 26) turn off (OFF state). During the dead time, the current flows through the parasitic diodes 31 to 33 of the first switching elements (FETs 21 to 23) or the parasitic diodes 34 to 36 of the second switching elements (FETs 24 to 26) in dependence on the direction of current flowing between the inverter circuit 20 and the motor 2 before the switching elements are turned off. Since the magnitude of this current varies with the voltage Vf, it is possible to determine, by confirming the magnitude of the voltage Vf, in which direction the current is flowing between the inverter circuit 20 and the motor 2, that is, the direction (polarity) of the phase current flowing in the U-coil 11, the V-coil 12 and the W-coil 13.

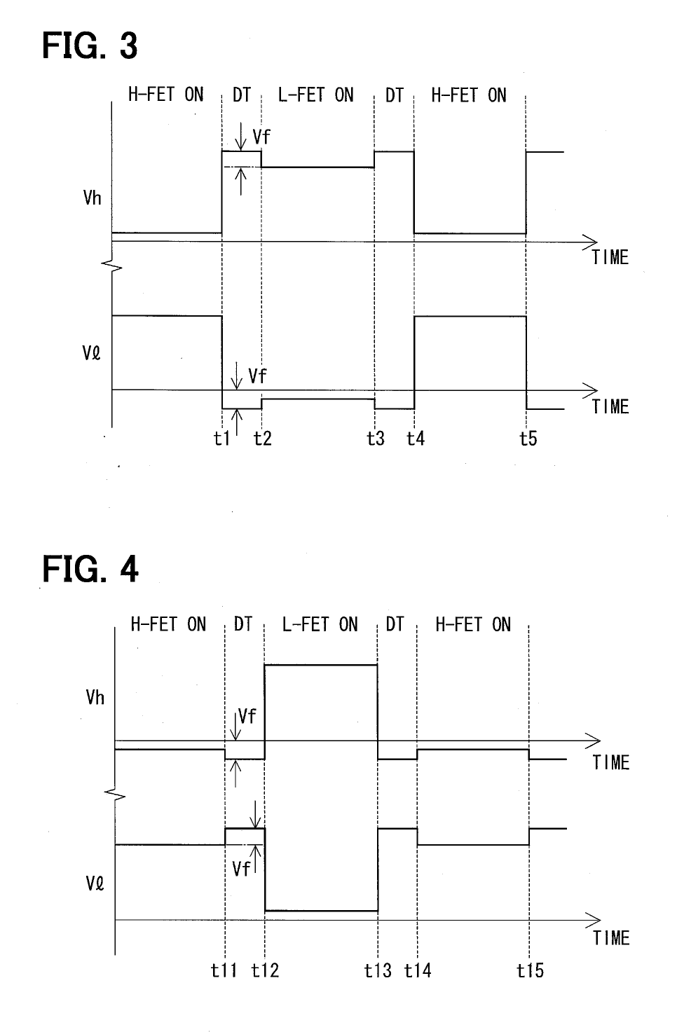

The direction of the phase current is determined in a manner described below with reference to FIG. 3 and FIG. 4. The method of determining the flow direction of phase current is the same among the phases (U-coil 11, V-coil 12, W-coil 13). Therefore, the description about the determination of phase current flow direction will be made only with respect to the U-phase (U-coil 11) to simplify the description about the determination of the same with respect to other phases V and W.

FIG. 3 shows changes of the first potential difference (Vh) and the second potential difference (Vl), which are caused by the on/off operations of the U-H-FET 21 and the U-L-FET 24 when the current flows between the inverter circuit 20 and the motor 2 in a direction from the inverter circuit 20 to the motor 2. Here, between the inverter circuit 20 and the motor 2, the direction from the inverter circuit 20 to the motor 2 is assumed to be a positive direction and the direction from the motor 2 to the inverter circuit 20 is assumed to be a negative direction.

As shown in FIG. 3, until time t1, the U-H-FET 21 and the U-L-FET 24 are in the on-state and the off-state, respectively. As a result, the current flows from the battery 3 to the motor 2 through the U-H-FET 21. During a period from time t1 to time t2, the U-H-FET 21 and the U-L-FET 24 are both in the off-state because of the dead time DT. The motor 2 tends to continue to flow the current. However, since the U-H-FET 21 is in the off-state, a current flows through the parasitic diode 34 of the U-L-FET 24. At this time, the first potential difference (Vh) increases by an amount of the voltage Vf and the second potential difference (Vl) decreases by an amount of the voltage Vf.

During a period from time t2 to time t3, the U-H-FET 21 is in the off-state and the U-L-FET 24 is in the on-state. Since the motor 2 tends to continue to flow the current, a current flows from the ground side to the motor 2 through the U-L-FET 24. During a period from time t3 to time t4, the U-H-FET 21 and the U-L-FET 24 are both in the off-state again because of the dead time DT The motor 2 tends to continue to flow the current. However, since the U-L-FET 24 is in the off-state, a current flows through the parasitic diode 34 of the U-L-FET 24. At this time, similarly to the period from time t1 to time t2, the first potential difference (Vh) increases by an amount of the voltage Vf and the second potential difference (Vl) decreases by an amount of the voltage Vf. The operation in a period from time t4 to time t5 is the same as in the period before time t1.

FIG. 4 shows changes of the first potential difference (Vh) and the second potential difference (Vl), which are caused by the on/off operations of the U-H-FET 21 and the U-L-FET 24 when the current flows between the inverter circuit 20 and the motor 2 in a direction from the motor 2 to the inverter circuit 20 (negative direction).

As shown in FIG. 4, until time t11, the U-H-FET 21 is in the on-state and the U-L-FET 24 is in the off-state. Assuming that a current was flowing in the negative direction, the motor 2 tends to continue to flow the current. As a result, the current flows from the motor 2 to the battery 3 through the U-H-FET 21.

During a period from time t11 to time t12, the U-H-FET 21 and the U-L-FET 24 are both in the off-state because of the dead time DT. The motor 2 tends to continue to flow the current. However, since the U-H-FET 21 is in the off-state, a current flows through the parasitic diode 31 of the U-H-FET 21. At this time, the first potential difference (Vh) decreases by an amount of the voltage Vf and the second potential difference (Vl) increases by an amount of the voltage Vf. During a period from time t12 to time t13, the U-H-FET 21 is in the off-state and the U-L-FET 24 is in the on-state. Since the motor 2 tends to continue to flow the current, a current flows from the motor 2 to the ground through the U-L-FET 24.

During a period from time t13 to time t14, the U-H-FET 21 and the U-L-FET 24 are both in the off state because of the dead time DT. The motor 2 tends to continue to flow the current. However, since the U-L-FET 24 is in the off-state, the current flows through the parasitic diode 31 of the U-H-FET 21. At this time, similarly to the period from time t11 to time t12, the first potential difference (Vh) decreases by an amount of the voltage Vf and the second potential difference (Vl) increases by an amount of the voltage Vf. The operation in a period from time t14 to time t15 is the same as in the period before time t11. It is thus possible to determine the direction of current flow, because the direction of current flow affects differently on the first potential difference (Vh) and the second potential difference (Vl).

For this reason, the control unit (microcomputer 40 and the customized IC) can determine the direction of the phase current by detecting the first potential difference (Vh) and the second potential difference (Vl) while the U-H-FET 21 and the U-L-FET 24 are both in the off-state, that is, during the dead time DT For example, if the first potential difference (Vh) and the second potential difference (Vl) detected in the dead time are an increase of the voltage Vf and a decrease of the voltage Vf, respectively, the direction of the phase current is determined to be positive (direction from the inverter circuit 20 to the motor 2). If the first potential difference (Vh) and the second potential difference (Vl) detected in the dead time are a decrease of the voltage Vf and an increase of the voltage Vf, respectively, the direction of the phase current is determined to be negative (direction from the motor 2 to the inverter circuit 20). Thus the microcomputer 40 operates as a current direction determination part and can determine the phase current flow direction based on the first potential difference and the second potential difference caused during the dead time.

According to the present embodiment, it is possible to detect a phase of an actual current, which is actually flowing in the U-coil 11, the V-coil 12 and the W-coil 13 of the motor 2, by detecting a time, at which a direction of a phase current changes from positive to negative (phase current becomes zero) or a direction of a phase current changes from negative to positive (phase current becomes zero). The microcomputer 40 detects the phase of the actual current flowing in the motor 2 by detecting the first potential difference (Vh) and the second potential difference (Vl) as a time point, at which the direction of the phase current changes from positive to negative (phase current becomes zero) or the direction of the phase current changes from negative to positive (phase current becomes zero). The microcomputer 40 then calculates a phase difference between the command current and the actual current based on the phase of the detected actual current relative to the phase of the command current. The microcomputer 40 thus operates as a phase difference calculation part.

According to the present embodiment, the microcomputer 40 calculates, after calculation of the phase difference between the command current and the actual current, the command current by correcting the phase difference so that the phase difference becomes zero. That is, the microcomputer 40 performs feedback control in relation to the command current. The microcomputer 40 thus operates as a phase difference correction part.

The present embodiment has the following features.

(1) The inverter circuit 20 includes plural switching elements (FETs 21 to 26), which form the switching element pairs 27, 28, 29 by FETs 21, 22, 23 provided at the high-potential side of the battery 3 and the FETs 24, 25, 26 provided at the low-potential side of the battery 3 in correspondence to the U-coil 11, the V-coil 12, the W-coil 13, respectively. The inverter circuit 20 further includes the diodes 31, 32, 33 provided in parallel to the FETs 21, 22, 23, respectively, and the diodes 34, 35, 36 provided in parallel to the FETs 24, 25, 26, respectively. The inverter circuit 20 converts the power supplied from the battery 3 to the motor 2 by the on/off operations of the FETs 21, 22, 23 and the FETs 24, 25, 26. The microcomputer 40 controls driving of the motor 2 by controlling the on/off operations of the FETs 21, 22, 23 and the FETs 24, 25, 26.

The microcomputer 40 operates as the current direction determination part. The microcomputer 40 can detect the first potential difference, which is the potential difference between both ends of each diode 31, 32, 33, and the second potential difference, which is the potential difference between both ends of each diode 34, 35, 36, when both of the FET 21 and the FET 24, both of the FET 22 and the FET 25 or both of the FET 23 and the FET 26 are turned off (in off-state). The microcomputer 40 can further determine the direction of current flowing in the U-coil 11, the V-coil 12, the W-coil 13 based on the detected first potential difference and the detected second potential difference. The direction of current flowing in the U-coil 11, the V-coil 12, the W-coil 13 can be determined in a simplified configuration without using a current sensor such as a shunt resistor and or the like. The rotary electric machine control apparatus 1 can be reduced in size and manufactured in low cost.

(2) Further, the microcomputer 40 operates as the phase difference calculation part. The microcomputer 40 can calculate the phase differences between the command currents for driving the motor 2 and the actual currents flowing actually in the U-coil 11, the V-coil 12, the W-coil 13, based on the determined flow directions of the currents flowing in the U-coil 11, the V-coil 12, the W-coil 13.

(3) Still further, the microcomputer 40 operates as the phase difference correction part and corrects the phase difference between the calculated command current and the actual current. By thus performing the feedback control to correct the phase difference, driving of the motor 2 can be controlled with high accuracy

(4) Still further, the diodes 31, 32, 33 and the diodes 34, 35, 36 are parasitic diodes of the FETs 21, 22, 23 and the FETs 24, 25, 26, respectively. For this reason, in providing the first rectifying element and the second rectifying element in parallel to the first switching element and the second switching element, respectively, a rectifying element (diode) need not be provided separately as electronic component part. The rotary electric machine control apparatus 1 can thus be reduced in size and can lower the manufacturing cost.

(5) In addition, since the rotary electric machine control apparatus 1 can be reduced in size, the rotary electric machine control apparatus 1 is suitably applied in the electric power steering apparatus 10 or the like, which need be mounted in a specific limited space.

### Other Embodiment

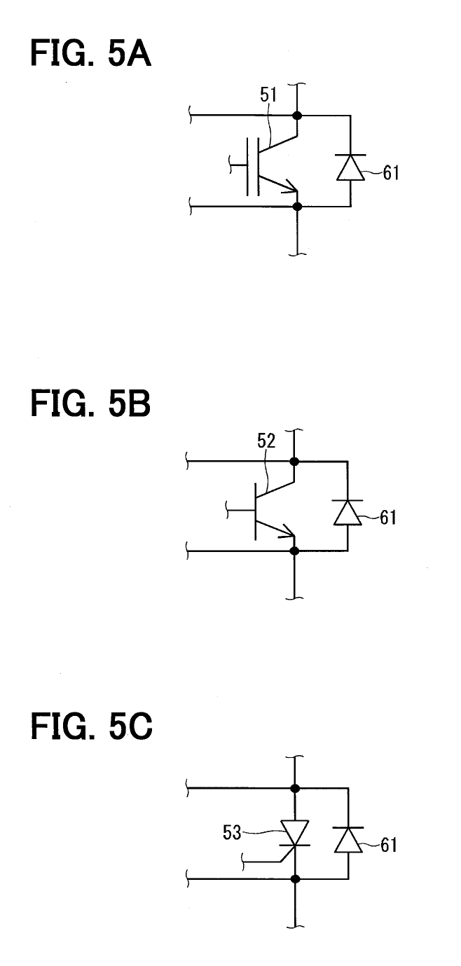

In the above-described embodiment, the first switching element and the second switching element are made of MOSFETs. The first rectifying element and the second rectifying element are formed of the parasitic diodes of the MOSFETs. However, as shown in FIG. 5A, each of the first switching element and the second switching element may be formed of an insulated-gate bipolar transistor (IGBT) 51. A diode 61 may be connected in parallel to the IGBT 51 as the first rectifying element or the second rectifying element.

As a still another embodiment, as shown in FIG. 5B, each of the first switching element and the second switching element may be formed of a transistor 52. The diode 61 may be connected in parallel to the transistor 52 as the first rectifying element or the second rectifying element.

As a still further embodiment, as shown in FIG. 5C, each of the first switching element and the second switching element may be formed of a thyristor 53, and the diodes 61 may be connected in parallel to the thyristor 53.

In the embodiments described above, the rotary electric machine control apparatus is applied to the three-phase brushless motor as an example. However, the rotary electric machine control apparatus may be applied to a brushless motor, which has four or more phases. The rotary electric machine control apparatus may control a rotary electric machine (motor and generator) other than the rotary electric machine for the electric power steering apparatus.

What is claimed is:

1. A rotary electric machine control apparatus for controlling driving of a rotary electric machine having a coil set formed of coils corresponding to plural phases, the rotary electric machine control apparatus comprising:
a power converter including plural switching elements, a first rectifying element and a second rectifying element, the plural switching elements forming switching element pairs by a first switching element and a second switching element, which are provided at a high-potential side and a low-potential side of a power source, respectively, in correspondence to each phase of the coils, the first rectifying element being provided in parallel to the first switching element, the second rectifying element being provided in parallel to the second switching element, the power converter converting power supplied form the power source to the rotary electric machine by on/off operations of the first switching element and the second switching element; and
a control unit for controlling the on/off operations of the first switching element and the second switching element thereby to control driving of the rotary electric machine,
wherein the control unit includes a current direction determination part, which detects a first potential difference between both ends of the first rectifying element and a second potential difference between both ends of the second rectifying element when the first switching element and the second switching element are both in an off-state, and determines a direction of a current flowing in each phase of the coils based on the first potential difference and the second potential difference.

2. The rotary electric machine control apparatus according to claim 1, wherein:
the control unit includes a phase difference calculation part, which calculates a phase difference between a command current for driving the rotary electric machine and an actual current flowing actually in the coil based on the direction of current flowing in each phase of the coils determined by the current direction determination part.

3. The rotary electric machine control apparatus according to claim 2, wherein:
the control unit includes a phase difference correction part, which corrects the phase difference between the command current and the actual current calculated by the phase difference calculation part.

4. The rotary electric machine control apparatus according to claim 1, wherein:
the first rectifying element and the second rectifying element are parasitic diodes of the first switching element and the second switching element, respectively.

5. An electric power steering apparatus comprising:
the rotary electric machine control apparatus according to claim 1; and
a rotary electric machine for outputting an assist torque for a steering operation of a vehicle.
